(19) United States
(12) Patent Application Publication
(10) Pub. No.: US 2010/0313515 A1
(43) Pub. Date: Dec. 16, 2010

(54) COMPOSITE CELLULOSE ELEMENT

(76) Inventors: Lothar Betz, Kalbach (DE); Willi Zehe, Burkardroth (DE)

Correspondence Address: EDWIN D. SCHINDLER, 4 HIGH OAKS COURT, P.O. BOX 4259, HUNTINGTON, NY, 11743-0777, US

(21) Appl. No.: 12/741,077

(22) PCT Filed: Oct. 31, 2008
(86) PCT No.: PCT/DE2008/001777

§ 371 Date: Sep. 1, 2010

(30) Foreign Application Priority Data
Nov. 3, 2007 (DE) 10 2007 052 596.8

(51) Int. Cl. B32B 9/06; E04C 2/34; E04B 1/78; E04C 2/38

(52) U.S. Cl. 52/588.1; 52/793.1; 52/794.1

(57) ABSTRACT

A composite cellulose element for drywall walls, ceilings and floors of buildings, which is composed of a cellulose-containing material with hollow spaces that are enclosed therein. The composite cellulose element are formed as boards or panels with each board or panel preferably having a plurality of sheets or thin boards forming layers that are affixed together. Several of the layers of sheets or thin boards have a profile of a wave or meander. Numerous hollow spaces are formed within the profile. A plurality of such composite cellulose elements can be connected to one another.

The invention relates to a pulp composite element for drywalling walls, decks, and floors of buildings, which is composed of pulp-containing material with cavities enclosed therein.

Cellulose is a component of the cell walls of plants, comprising over 50%, and is therefore one of the most common organic compounds on Earth. Its chemical formula is (C₆H₁₀O₅)_{N}. Technically, cellulose is obtained from wood as so-called “pulp” by grinding, and serves as the basic material in the paper industry, the clothing industry, and as a raw material for numerous other applications in other fields. For centuries, cellulose has been familiar as the essential component of paper and board. Under the microscope, it becomes clear that the individual fibres are oriented in disparate directions and highly intermeshed with one another in a similar way to a non-woven fabric. From this, it emerges that paper and board can be loaded with relatively high tensile forces in the planar direction. On the other hand, they can be bent with relatively very low forces perpendicular to the surface. With increasing thickness, a paper can always receive higher compressive forces in its plane, and is then known as cardboard. From about 1.5 mm thickness and an areal weight of about 600 g/m², it is known as board.

Cellulose is insoluble in water and most organic solvents. The solubility of most papers and boards in water is therefore determined not by the base material but by the adhesives used to bond the cellulose fibres.

Since the tensile load bearing strength of paper or board in the plane is considerably higher than the compressive load bearing strength, a sheet of paper or a piece of board can withstand considerably higher compressive forces it is curved in the manner of a column or tube, because the compressive forces can thereby be directed into the now curved surface of the paper.

Therefore, as early as 1871, a corrugated profiled cardboard was bonded with the extreme portions of the hills and valleys of its corrugations between two flat cardboard portions. This material, as corrugated board, is the foremost base material in the packaging industry, where it proves its bearing strength including for the transport packaging of goods with particularly high weight, such as combustion engines. On the other hand, because of the economical and universally available raw material, and a wide variety of perfected processing machinery it is one of the most economical board materials that is available in the prior art.

Therefore board and corrugated board from the prior art are also a component that is used in building construction as one of a plurality of layers in panels and composite materials. There have also been repeated attempts to increase the, so far, very low percentage of corrugated board in building construction, and use the material not only as one of a plurality of layers but to form significant components of walls and roofs therefrom.

Thus, U.S. Pat. No. 4,346,541, Schmitt, describes a panel for walls and decks that is made of repeatedly folded corrugated board, the cavities of which are filled with polyurethane. Outwardly, the corrugated board is covered with a plastic film and is provided with this weathering protection for outer walls and roofs. A major disadvantage of this design, however, is that the corrugated board is repeatedly folded. The folding requires that, at the kink points along the folding lines, the corrugated layers of the corrugated board are pressed together, reducing the insulating effect of the corrugated board. A further disadvantage is that, at the folding points, a multiplicity of fibres are either themselves ruptured or detached from the bond with the adjacent fibres, further weakening the material. Not least, to reinforce these regions considerably weakened by folds and kinks, in U.S. Pat. No. 4,346,541, the cavities are filled by foaming with polyurethane.

U.S. Pat. No. 6,557,308, Snell, describes small single-storey houses that are manufactured entirely of corrugated board. For manufacturing, the positive form of a house, consisting of floor, walls and roof, is set up in one piece; multiple layers of corrugated board are wound around this form and bonded to one another. By bonding the individual layers, a quasi monolithic design of floors, walls and roofs is created, but without decks. The decisive disadvantage is that a very bulky part is produced, which, because of its large cavity, can only be transported with disproportionately high outlay. The maximum possible heights, widths and lengths for transportation limit the dimension of the houses that can be produced according to this process. Relatively large houses must be produced with the corresponding moulds in situ, for which purpose correspondingly gigantic mould and the cranes necessary therefor are required. A considerable disadvantage of this principle, however, is that, according to this process, hollow bodies which are open at both sides are created, the efficient and durable bonding of which remains unexplained. The creation of the gable walls is also not specified in detail.

As a further alternative, the folding together of the created hollow article by incising and folding at points with very narrow radius of curvature is described. As a result of this folding, however, the corrugated board—as already described above—is considerably weakened. The subsequent folding back to the original form further weakens the connecting point, such that it becomes a predetermined breaking point.

Against this background, the object of the invention is to develop a construction element for building construction that consists predominantly of corrugated board and is also suitable for multi-storey building construction, can be produced on existing machinery, can be shipped with conventional means of transport and can be installed within a short time using the aids that are conventional in dry construction techniques, and thus permits the production of inexpensive, energy-economical, recyclable buildings.

As a solution, the invention presents a composite pulp element in which each panel consists of a plurality of layers of sheets or thin panels, which are bonded to one another, and of which a plurality have the profile of a corrugation or a meander, and, within this profile, form a multiplicity of hollow cavities, and a plurality of panels can be bonded to one another.

The decisive element of the invention is thus that the panel-shaped construction elements for walls, floors, decks, roofs, stairs and other installations and annexes of a building construction consist almost predominantly of pulp, which—in the manner known principally for corrugated board—consists of a plurality of sheets that are laminated with one another and bonded together. At most, each second sheet is profiled, specifically in the form of a corrugated line or in the form of a meander, that is created by the continuous angling of a strip, specifically with two rightwardly directed angles are followed by two leftwardly directed angles, and then two rightwardly directed angles again, the angle preferably lying in the range of 90 degrees, in principle, however, each value can be greater than 0 and smaller than 180 degrees.

The decisive advance of the composite pulp elements according to the invention compared to the prior art is the connection of one element to the next. From packaging technology, as well as from the prior art for the use of corrugated board in building construction, corrugated board portions for use in building construction, particularly at corner connections, are joined by angling portions of the corrugated board and joining them to the next corrugated board element, usually by bonding, but also in some cases by means of additional other bonding elements.

As already mentioned in the prior art, a serious disadvantage thereof is that, as a result of the angling or bending, the thickness of the corrugated board is reduced and thereby its bearing strength reduced, and a further important disadvantage is that, as a result of the cavity created by the profiled sheets, its volume is reduced, which reduces the thermal insulation, and if the angling is too acute, individual sheets are even torn, causing adjacent cavities to be connected to one another, which leads to an increase in the air exchange between these cavities, and thereby to a significant reduction of the thermal insulation.

For the person skilled in the art, the angling or bending of the layers, which is also used in most applications, is an obvious step, and therefore so widespread.

In contrast thereto, the decisive advantage of the composite pulp element according to the invention is that, for bonding the panels, certain layers, or the entire panel, do not necessary have to be angled and kinked. The principle of the invention therefore does not exclude forming, as a variant, e.g. small tabs, which, as installation aid, are angled and inserted into corresponding slots in the adjacent panel. In contrast to most other construction elements with a pulp portion, however, the invention is by no means dependent thereon.

A very interesting embodiment of the invention is that a panel joiner is directly integrated into the end edges, which avoids the angling or bending over of the layers, as a result of which the weakening of the bearing strength and insulation caused by the bending over is avoided.

In a very simple case, it would be conceivable to design the composite pulp elements as rectangular panels, which are bonded to one another by means of mounted connecting strips. These laterally mounted connecting strips are either planar elements, which are bonded across the joint between two adjacent elements and/or elongated fastening elements, such as screws, which extend through openings in the composite pulp elements. Planar connecting strips can in this way be additionally secured by means of such elongated fastening elements. This type of connection additionally also resists tensile forces, which would otherwise separate the two mutually connected panels.

It is also conceivable to bond the two adjacent panels to one another by means of an adhesive layer at the end faces. It is particularly notable that—in particular in the case of sheets extending parallel to the outer side—the end faces of the profiled sheets are not precisely opposite one another, so that the adhesive does not only need an adequate bonding effect, but additionally also forms a self-supporting layer, with the help of which it bridges the end regions of the cavities in the profiled sheets, and produces a tensile force-resistant connection between the adhesive layer and the profiled sheets. It should be noted that the adhesive layer, which usually runs from the outside to the inside, is not a particularly good thermal conductor and therefore does not transmit undesirable heat into the interior.

The aforementioned forms of joining show that the type of chosen panel connection should be matched to the orientation of the sheets in the pulp connection elements according to the invention. A plurality of types of orientation of the sheets are thereby conceivable:

The invention prefers the orientation of the sheets parallel to the outer surface of the panels. An advantage is that, at one edge, all sheets of the panel connection run through as far as the opposing panel connector at the other side, by means of which the panel is resistant to much greater compressive and tensile forces than in the case in which the sheets run perpendicular to the outer surface. Another advantage is that the open end faces of the profiled sheets are only oriented in the region of the panel connections, where they are covered by the panel connection or by the adjacent panel.

On principle, it is also conceivable to orient the sheets of a composite pulp element according to the invention perpendicular to the outer surface. An advantage is that such elements can be relatively easily formed into domed elements, even on the construction site. The restriction, however, is that the cavities of the profiled sheets then become visible on the outer surface, and must be covered with a further layer. In addition, the stability of the composite element is lower than in the case of sheets extending parallel to the outer surface.

In the interests of maximum stability, that is to say identical load-bearing stability at each point, the corrugation hills and valleys of the corrugated profiled sheets have approximately the same width. It is also advantageous if they run parallel to one another. The same applies for the lines of the angling of meanderingly profiled sheets, the meandering form being created advantageously, not by multiple angling of a cardboard surface that is initially completely planar, but is formed already during manufacture of the meanderingly shaped profile into the still-movable mass of pulp fibres and connecting material, so that, after hardening, no fibres are broken or detached from the binding adhesive, even at the angle points.

In the case of wall elements that are also required to assume load-bearing functions, for example walls, it is appropriate to orient the corrugation lines of the profiled layers in the direction of maximum force, that is to say perpendicular in the case of walls.

There may be applications, such as deck panels of relatively large span width, in which the best load-bearing strength is obtained if the orientation of the corrugation hills of one profiled layer alternates from layer to layer, so that the corrugation lines of adjacent layers cross one another. For rectangular slabs, it is appropriate to orient the crossing angles at 90 degrees.

The preferred form of a composite pulp element is probably rectangular in practice, because this gives the most combinatory possibilities, and because the predominant majority of all building equipment objects and all construction materials are coordinated to rectangular forms.

As already explained, a major advantage of the composite pulp elements according to the invention is that they contain a multiplicity of very small cavities through their cross-section. Up to a certain limit, the ever smaller cavities and therefore the increased number of cavities over a given cross-section improve the thermal effect of a panel. A further increase of the insulating effect can be achieved in that as many of the profiled sheets as possible are provided on at least one side with a heat-reflecting coating, e.g. an aluminium foil. In addition to the reduction of the heat exchange due to convection by means of the multiplicity of small cavities, the heat transfer by radiation is also thereby further blocked.

Pulp is by its nature not water soluble, and therefore readily suitable for use as construction material. By means of the adhesive for bonding the individual adhesive fibres and therefore by means of corresponding additives and/or corresponding coating of the fibres and/or of the sheets and/or of the construction elements, they can be made flame retardant or hardly flammable and/or moisture repellent or water resistant and/or fungicidal and/or termite-resistant and/or biodegradable and/or electrically conductive.

A further appropriate reinforcement is a layer of a mesh-like or textile material, if this layer is disposed on the outer surface or close to the outer surface, the resistance of the outer surface is thereby increased. In an alternative embodiment, the filaments of this layer can be introduced into the panel connector and connected to the panel connector. This configuration further increases the tensile strength of the panel.

If the mesh is woven of wires, and if these wires are led into the panel connection, and there connected to the wires of the adjacent composite pulp element, considerable tensile forces can also be absorbed by the overall structure. As a further reinforcement, it is conceivable to construct interlayers of metal. These metal areas can be used as electrical shielding of the interior space if they are connected to identical metal areas in adjacent panels. Alternatively, it is also conceivable to connect only the metal layers of a few selected elements to one another and in this manner to form receiving antennas, whose properties can be tuned to the frequency to be received.

If the metal areas are designed very robustly and the connection of the metal areas is very highly load bearing, for example by screwing, the resulting structure can also withstand very high forces.

Alternatively, the inserted interlayers can also perform other functions, such as heating or cooling.

Depending on the desired construction of the wall, a vapour-barrier film can also be appropriate as an interlayer.

In principle, it is also readily possible for a composite pulp element according to the invention to introduce an interlayer of an arbitrary other material. Typical materials are metal, gypsum, fibre-reinforced gypsum, concrete, fibre-reinforced concrete, porous concrete, plastic, clay, wood or wood-based material, or plaster lathing with plaster. The thickness of the layer, the positioning of this layer either close to the inner wall or in the centre, or close to the outer wall, and the selection of the material in between may be dependent on the overall concept of the building and its physical design.

A further interesting alternative is to fill some cavities or a plurality of profiled layers with sand. By this means the sound-insulating effect of the element is further reinforced, with the ratio between the weight increase and the sound insulation achieved being particularly favourable, because a significant proportion of the energy contained in the sound pressure is dissipated by the sonic movement of the sand grains with respect to one another.

As another alternative, some cavities of at least one profiled layer can be filled with an insulating material, by which means the thermal resistance of the construction element and therefore the insulation capability is increased.

A further advantageous option is an airtight and/or watertight film, which surrounds the entire composite pulp element. By this means, not only the construction element itself is protected against moisture or aggressive gases, but the cavities in the interior can also be at least partly evacuated, by which means the insulation capacity of the element is significantly increased. Alternatively, within the surrounding film, some cavities can be filled with a gas, by which means the insulation properties can be improved in comparison to air filling.

Even if, within the film covering, only air is present in the cavities, the separating film permits this air to be dried before it is introduced, so that only a little condensation water, or none at all, forms in the interior, even in the case of temperature fluctuations.

A further useful option is the introduction of empty spaces or cavities for installation lines, which can perform the supply with electricity, water, gas, air and other means. Elements are also conceivable that contain openings for doors, windows, hatches or other installations. It is possible to install these elements during production and only assemble them on site together with the composite pulp element according to the invention. This includes doors, windows, hatches, flaps, switch boxes, heating elements, cooling elements, lighting fixtures, electric switches, sanitary elements or wall cabinets.

As already described, it is an important feature of the composite pulp panels according to the invention that a suitable panel connector is integrated, for which the most diverse embodiments are possible and conceivable. A very simple form is an edge depression. Such a depression can be introduced into a panel by, e.g., machining, such as cutting or milling. However, it is more interesting to form the depression by building up the panel from sheets of different sizes, because in that case no waste is produced.

A particularly interesting embodiment of the edge connector, which is tailored to the structure of the panel according to the invention, is to omit the profiling of some layers in the edge region, as a result of which the cross-section in the edge region becomes smaller. The result of this is that the layer following a profiled layer is led down in a stepped manner to the non-profiled region.

This stair can naturally be formed by double bending over of the respective sheet. However, because the sheet is somewhat weakened at the folding points, it is even more advantageous to introduce this shoulder directly during production of the still-soft sheet. From this, there results and approximately trough-shaped part, the angled regions of which are just as stable as the planar regions.

The edge depression can be design not only as a notch, but also as a groove. For joining a plurality of panels to form a large surface, it is particularly advantageous if the edge depression is formed so as to be complementary to the edge region of another similar panel. Here, it is particularly advantage if there is a fold that projects beyond the end face of the adjacent panel and complementary to the edge depression of one panel.

It is also conceivable that two adjacent panels each have a depression that is filled such that it is flush again with a connecting strip, as a third element that projects halfway into one panel or lines on a notch. As a result construction elements are produced whose connection is designed as a tongue and groove. Such a means of connection is possible even with the exclusive use of identical panels in which mutually opposite edges are designed so as to be complementary to one another and in this way can be plugged together in a modular manner.

As the shape of the panel, a rectangle is most obvious—as already mentioned—since it permits very varied combinations. However, it is also conceivable to use hexagonal panels, which are fitted together like honeycombs. Regular hexagons whose end faces assume an angle of less than 90 degrees to the outer face are particularly good for the construction of polygonal cupolas or domes. Panels that are formed as a regular octagon require, as a further element for filling the gaps, squares with the same edge length as the octagon.

In principle, curved outer lines are possible for the contour of the panels, wherein outer lines must suitably lie opposite one another so as to be complementary to one another so that all elements can be fitted seamlessly together.

For the assembly and dispatch of composite pulp elements according to the invention, it is advantageous if the panel connector function of the edge region is formed not only as a notch or groove but is additionally reinforced by stiffening elements. These stiffening elements can be bonded, screwed, riveted, clamped or pressed to the sheets. As material for the reinforcing elements it is suitable to use principally wood or wood-based material.

In an interesting embodiment, the reinforcing elements are designed as U-shaped frames, the legs of which face inward and engage at both sides in depressions of the panel that are arranged at both sides along the edge. If these edge strips are connected to one another to form a stable frame, they also permit the transmission of tensile forces through the panel. Alternatively or additionally thereto, the stiffening elements can be bonded to the end faces of the sheets or fixed to them by means of screws, clamps or other metal elements that pass transversely through the sheets.

With such wooden edge reinforcements, a composite pulp element according to the invention can be installed exactly as could be done with the panel elements conventionally used in dry construction. If, thus, the U-shaped stiffening at the edge of the panel is so narrow that a shoulder remains opposite the outer face, then—as mentioned above—this can be filled with a connecting strip that, with its other half, projects beyond the notch of the remaining panel and terminates flush therewith.

A composite pulp element according to the invention can be equipped on its outer surface and/or on its inner surface with a wide variety of materials and substances as weathering protection and/or as decoration and/or as reinforcement. To be mentioned are trapezoidal sheet, other metal sheets, roof tiles, roof elements, concrete slabs, ceramic slabs, wall tiles, plastic panels, plastic elements, gypsum boards, wood panels, floor covering, solar elements, embossed relief, wallpapers, decorative films, paint layers and/or plaster applied to plaster lathing.

It is also conceivable that, in the interior of the composite pulp element, a cavity is present, which either remains empty or is filled with another insulating and/or reinforcing material.

As an addition to the composite pulp elements according to the invention, elements of wood or of wood-based materials have been mentioned. These elements can be formed, in a particularly lightweight and at the same time very stable alternative, from three wood layers, of which a first layer is corrugated and connected, at the corrugation hills, to a second flat wood layer and, at the reverse side of the corrugation valleys, to a third flat wood layer so that a multiplicity of cavities is formed between the wood layers. These wood elements are thus constructed similarly to the layers of the composite pulp element, but consist of very much thicker layers. They are therefore also more strongly load bearing. this contrasts with an increased effort in particular for forming the central corrugated layer.

As tools for this process, rollers or punches with corrugated surfaces are suitable. At high temperature and/or moisture contents, they deform a wooden panel in a corrugated form. Then the corrugated panel has to be cooled and dried and can be, e.g., adhesively bonded to flat wooden panels.

Composite pulp elements according to the invention are universally applicable for walls, facing formworks, face walls, roofs, decks, floors, stairs, partition walls and other planar elements.

For bonding a plurality of panels into a wall, it is a particularly interesting embodiment of the composite pulp element to provide the individual panels at the entire edge with a surrounding, rectangular notch, which can be filled with connecting strips formed complementary thereto. These connecting strips are preferably twice as wide as the notches surrounding the edge side. They can thereby be inserted into the two notches of two adjacent panels. If the depth of the notch corresponds to the thickness of the connecting strips, the outer surface of the connecting strip terminates flush with the outer surface of the panels. As a result there is created a flat outer surface of the wall, within which the panels are connected to one another by means of the connecting strips such that they are resistant to tensile and compression forces.

As material for the connecting strips it is suitable to use principally wood or wood-based material. Even if the reinforcing elements are formed of the same material in the region of the panel connectors, the connecting strip can be effectively screwed and/or adhesively bonded to the reinforcing elements. It is also conceivable to use nails, clamps or connecting plates, which have a multiplicity of triangular metal teeth notched at both sides, which can be pressed in between the reinforcing element and connecting strip in the manner of a nail.

An advantageous application is, e.g., a wall with vertical supports and/or horizontal bars of wood, metal, or concrete, which are fitted between the panels according to the invention. In the case of roofs, composite pulp elements can bear all loads themselves without additional support structure up to certain span widths.

Even decks of low span width, e.g. over corridors, are conceivable from composite pulp elements according to the invention. An increase of the load bearing strength can be achieved in that the cross-section of the deck is developed in the manner of a dome, i.e. has a smaller cross-section in the centre of the deck than towards the outside. For this application, deck elements are conceivable that have a trapezoidal cross-section, so that the deck forms a flat surface at its top surface but the lower edge is polygonal.

If the decks are to bridge greater span widths, panels according to the invention or entire composite pulp elements can be mounted between or on the deck beams.

Even steps are possible, which can be made entirely of composite pulp material if it is thick enough. Here, too, the individual steps can be formed as trapezoidal elements in cross-section. Alternatively, it is conceivable to join square panels into L-shaped construction elements, which form the step surface and the front edge of a step. These elements can be inserted into wall elements at both sides. Alternatively they can also be mounted on inclined beams as supports or inserted between them. For stairs of large width, it may be appropriate to support the composite pulp elements according to the invention by means of additional supports extending transversely to the direction of the stairs.

Further details and features of the invention are explained below in greater detail with reference to examples. However, they are not intended to limit the invention but only explain it. In schematic view,

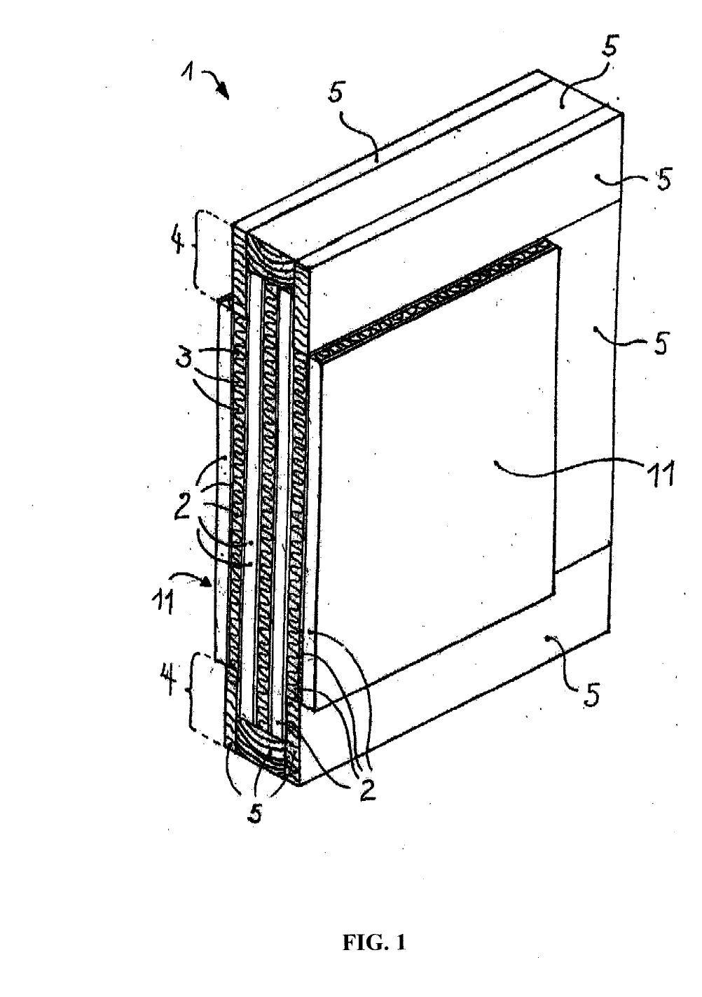

FIG. 1 shows a perspective view of a cut panel

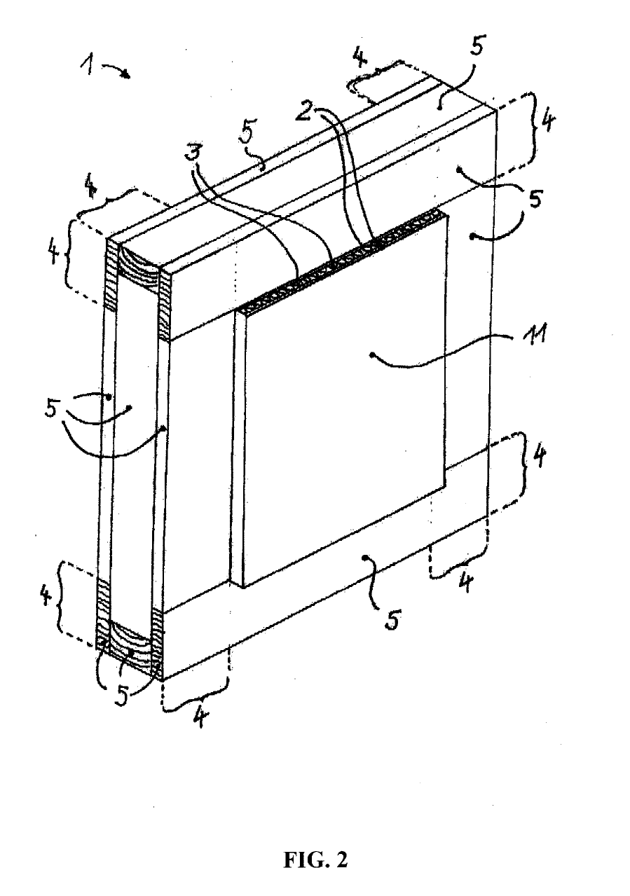

FIG. 2 shows a complete view of the cut panel in FIG. 1, and

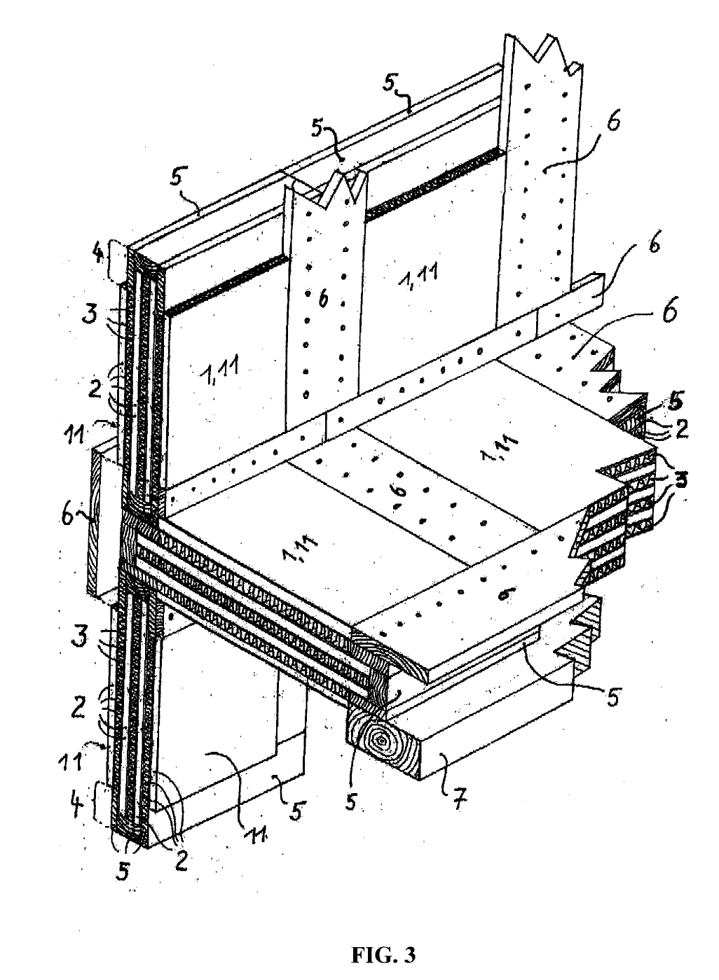

FIG. 3 shows a section through a deck-wall connection with the panels shown in FIG. 1 and FIG. 2

FIG. 1 shows a panel 1 as part of a composite pulp element according to the invention. In this variant, it consists of corrugated sheets 2 oriented crosswise to one another, which are in each case bonded to one another by means of a sheet 2 as interlayer.

The embodiment shown in FIG. 1 has a total of seven profiled sheets 2, which in this case have corrugated profiles. Since they are oriented crosswise to on another, total of three profiled sheets 2 can be seen in the cut plane of FIG. 1.

Adjacent to the two outer surfaces 11 of panel 1, one further profiled layer in each case can be recognised. Their cavities 3 can still be seen at the edge of the outer face 11 of the ready-to-install panel 1, Subsequently—as shown in FIG. 3—they will also be covered by, the side edge of a connecting panel 6.

In the embodiment in FIG. 1, a rectangular notch surrounding the edge side, as the panel connector 4 of panel 1, is shown. This notch is so deep that a profiled sheet 2 is outwardly visible. In the edge notch, reinforcing elements 5 are inserted parallel to the outer surface 11 and adhesively bonded in place. Between these two reinforcing elements 5, a third reinforcing element 5 is inserted and at least adhesively bonded, however preferably doweled and/or screwed.

As material for the reinforcing elements, wood or a wood-based material is preferred, since it has been proven for centuries for the dry construction of buildings and therefore a very rich spectrum of experience and tools are available.

In FIG. 1, it is readily visible that the volume of a panel 1 according to the invention consists of a very large number of rod-shaped cavities 3, which extend between the corrugation hills and corrugation valleys of the profiled sheets 2.

FIG. 1 clearly shows that, in the cross-section of a panel—even in this very simply constructed example—seven mutually separated cavities must be overcome from the outside to the inside, which makes a very good insulating effect likely.

In FIG. 2, the panel 1 shown in FIG. 1 is drawn as a complete construction element. FIG. 2 makes it clear that the panel 1 in this example is rectangular in form. All the reinforcing elements 5 arranged in the outwardly surrounding notch are connected to the four further reinforcing elements 5, arranged at the end faces, to form a U-shaped frame, which surrounds the panel 1 along all four edges. On the faces of the panel 1, one further layer of a corrugated sheet 2 with a flat outer surface 11 projects as a relatively small rectangle.

In the embodiment in FIG. 2, the notch surrounding the edge side is half-filled with the reinforcing elements 5. In FIG. 2 it is clear that this reinforcing element 5 should be particularly intimately connected to the sheets 2.

However, FIG. 2 also makes it clear that with a very load-resistant connection of the total of twelve reinforcing elements 5 used here, the tensile load resistance of the panel connectors 4 is high, since tensile forces that act on one side on a reinforcing element 5 are further transferred via the two adjacent U-shaped reinforcing element 5 to the reinforcing element 5 opposite the loaded side, where they exert exclusively compressive forces onto the corrugated pulp element arranged in the interior of the panel 1.

FIG. 3 shows how the panels 1 presented in FIGS. 1 and 2 are completed into walls and decks and are connected to one another. FIG. 3 shows two horizontal panels 1, of which the rear one is cut at one corner, and thereby shows the 7 layers of profiled sheets 2, which contain numerous cavities 3. The two panels 1 connected to one another in the wall of the upper storey together form a composite pulp element.

As a wall for both storeys, three panels 1 are already installed, of which the two front ones are shown cut away, so that their internal structure is visible. The lower vertical panel 1 bears on its upper end face, as deck, a horizontally arranged panel 1, which, with its downwardly facing reinforcing element 5, which extends parallel to the outer surface 11, lies on the edge-side reinforcing element 5 of the vertical panel 1. Upwardly they bear two further panels 1, which form a composite pulp element for the wall of the upper storey.

FIG. 3 shows that the outwardly directed portion of the panel connector 4, facing away from the observer, of the lower vertical panel 1 forms a surface that is flush with the end face of the horizontally laid-on panels 11, which is in turn flush with the surface, within the panel connector 4, of the two panels 1 of the upper storey.

By means of the mutually flush planes of the edge strips 4 of the lower panels 1 with the upper panels 1, and the end face of the panels 1 used as deck, there is created at the outside of the building a horizontal notch, which is filled with a particularly broad connecting strip 6, which in FIG. 3 is drawn still at a distance from the notch.

In FIG. 3, two vertical connecting strips 6 are drawn in the wall of the upper storey, of which the left connecting strip 6 is connected to the two illustrated panels 1 and the right connecting strip lies with only one half on the panel connector 4 of the panel 1; the other half of the connecting strip 6 is still waiting for the next connecting panel 1.

In the base region of the wall of the upper storey, a plurality of very narrow connecting strips 6 can be seen, which cover that region of the horizontal panel connectors 4 that are not yet covered by those panels 1 that are used as deck, and complete it to form a flat wall.

The deck in FIG. 3 is constructed according to the same principle as the wall. A total of 3 horizontally arranged connecting strips 6 can be seen in the deck, of which the two right-hand ones are shown cut away. At the connecting strip 6 shown at the front, it is apparent that it is screwed in the rectangular groove at the front edge of the (deck) panels 11. There, it is screwed into the parallel reinforcing element 5, and projects forward.

Below the front, horizontal connecting strip 6 a large groove is formed, together with the vertical end face of the panel 1 and the top side of the deck beam 7. Into this groove, the next adjacent panel 1 is inserted and screwed.

In this embodiment, the ceiling beam 7 is shown in a very robust embodiment. It is also conceivable to replace it by vertically arranged narrow wood elements, which then support the load of the horizontally arranged panels 1.

In FIG. 3, as an alternative embodiment of the T-shaped connection of panels 1 according to the invention. It is shown that a further, third panel 1 is inserted between two panels 1, which are flush but spaced from one another. This form of the T-shaped connection is primarily suitable for the integration of decks into walls. However, it is also possible to join three meeting walls in this manner.

In FIG. 3 it is not shown that such a connection can also be formed by means of directly abutting, flush panels and a third panel 1 that is connected thereto at the end face.

### LIST OF REFERENCE CHARACTERS

1 Panel comprising a plurality of layers 2
11 Outer face of the panel 1
2 Sheets forming the layers of the panel 1
3 Cavity in panel 1
4 Panel connector, portion of panel 1 that serves for joining to an adjacent panel 1
5 Reinforcing element in the panel connector 4
6 Connecting strip connects two adjacent panels 1
7 Deck beam, bears two adjacent panels 1 as a deck panel

1-45. (canceled)

46. A composite cellulose element for drywall walls, decks and floors of buildings, comprising:
a relatively thick panel comprised of cellulose having cavities enclosed therein, said relatively thick panel comprising a plurality of relatively thin panels bonded to one another with more than one of said plurality of relatively thin panels having a profile of a corrugation or of a meander and, within said profile, a multiplicity of cavities are formed.

47. The composite cellulose element for drywall walls, decks and floors of buildings according to claim 46, wherein said relatively thick panel has end faces that are, at least partly, formed as a panel connected, which is connectable to an additional relatively thick panel.

48. The composite cellulose element for drywall walls, decks and floors for buildings according to claim 46, wherein more than one said plurality of relatively thin panels are profile-free and substantially form a plane or a slightly curved area.

49. The composite cellulose element for drywall walls, decks and floors for buildings according to claim 46, wherein said plurality of relatively thin panels are oriented approximately parallel to an outer face of said relatively thick panel.

50. The composite cellulose element for drywall walls, decks and floors for buildings according to claim 46, wherein at least one of the plurality of relatively thin panels are oriented substantially parallel to an outer surface.

51. The composite cellulose element for drywall walls, decks and floors for buildings according to claim 46, wherein said profile of said corrugation of said plurality of relatively thin panels having corrugation hills and corrugation valleys that are parallel to one another with said relatively thick panel.

52. The composite cellulose element for drywall walls, decks and floors for buildings according to claim 46, wherein said profile of said meander of said plurality of relatively thin panels has folding lines that run parallel to another with said relatively thick panel.

53. The composite cellulose element for drywall walls, decks and floors for buildings according to claim 46, wherein said profile of said corrugation of said plurality of relatively thin panels has corrugation hills or folding lines that are rotated for alternating with one another from layer to layer of said relatively thin panels.

54. The composite cellulose element for drywall walls, decks and floors for buildings according to claim 46, wherein said profile of said corrugation of said plurality of relatively thin panels has corrugation hills or folding lines that are rotated approximately 90° to one another.

55. The composite cellulose element for drywall walls, decks and floors for buildings according to claim 46, wherein at least one relatively thin panel of said plurality of relatively thin panels has a heat-reflecting coating on at least one side.

56. The composite cellulose element for drywall walls, decks and floors for buildings according to claim 46, wherein said relatively thick panel has cavities that are, at least, partially filled with sand.

57. The composite cellulose element for drywall walls, decks and floors for buildings according to claim 46, wherein said relatively thick panel has cavities that are, at least, partially filled with an insulating material.

58. The composite cellulose element for drywall walls, decks and floors for buildings according to claim 46, further comprising an edge depression as a panel connector.

59. A composite cellulose element for drywall walls, decks and floors of buildings, comprising:
a plurality of relatively thick panels bonded or connected to one another, each relatively thick panel of said plurality of thick panels being comprised of cellulose and having cavities enclosed therein, each said relatively thick panel comprising a plurality of relatively thin panels bonded to one another with more than one of said plurality of relatively thin panels having a profile of a corrugation or of a meander and, within said profile, a multiplicity of cavities are formed.
